(19) United States
(12) Patent Application Publication
(10) Pub. No.: US 2023/0361400 A1
(43) Pub. Date: Nov. 9, 2023

(54) SECONDARY BATTERY

(71) Applicant: SK ON CO., LTD., Seoul (KR)

(72) Inventor: Myeong Seon KWON, Daejeon (KR)

(21) Appl. No.: 18/306,251

(22) Filed: Apr. 25, 2023

(30) Foreign Application Priority Data
May 4, 2022 (KR) 10-2022-0055468

(51) Int. Cl. H01M 50/195; H01M 50/105; H01M 50/186

(52) U.S. Cl. CPC H01M 50/195; H01M 50/105; H01M 50/186

(57) ABSTRACT

A secondary battery includes an electrode assembly, and a pouch including an upper sheet and a lower sheet and accommodating the electrode assembly. The pouch is formed with a sealing portion sealing the upper sheet and the lower sheet on an outer portion. The sealing portion includes a polymer compound layer between the top sheet and the bottom sheet in at least a portion. The polymer compound layer includes a polymer compound, and the polymer compound is a thermally expandable polymer compound of a composite of a hydroxy group-containing polymer-silica hybrid, or at least one heat-shrinkable polymer compound selected from the group comprising polyphenylene ether (PPE), polycarbonate (PC), polyoxymethylene (POM) and polyamide (PA).

### CROSS-REFERENCE TO RELATED APPLICATION(S)

This patent document claims the priority and benefits of Korean Patent Application No. 10-2022-0055468 filed on May 4, 2022, the disclosure of which is incorporated herein by reference in its entirety.

### TECHNICAL FIELD

The technology and implementations disclosed in this patent document generally relate to a secondary battery.

### BACKGROUND

Lithium ion secondary batteries are batteries capable of repeating charging and discharging, and demand for the lithium ion secondary battery as an energy source is rapidly increasing as technology development and demand for mobile devices and electric vehicles have recently increased.

Lithium ion secondary batteries have a problem in which the cell pressure increases due to vaporization of the electrolyte solution as the internal temperature increases. When a certain threshold is reached, the temperature of the cell increases rapidly, and a chemical exothermic reaction occurs between the electrolyte and the electrode, further increasing the cell pressure. As described above, when the cell temperature continues to increase, a thermal runaway phenomenon may occur, and furthermore, there is a concern that heat generated in one cell may lead to a thermal propagation problem to an adjacent cell or an adjacent module.

Therefore, there is a need for a secondary battery capable of stably maintaining performance of the battery by preventing the thermal runaway or thermal propagation problem and ensuring the safety of the battery.

### SUMMARY

The disclosed technology can be implemented in some embodiments to improve stability of a secondary battery by selectively inducing a vent before the rapid phase transition of an internal temperature occurs such that gas or electrolyte, which is one of the causes of thermal runaway, may be removed, in the case in which there is a risk of gas generation inside of the secondary battery due to a thermal runaway situation in which a temperature inside of the secondary battery rapidly increases due to an abnormal reaction of the secondary battery.

In some embodiments of the disclosed technology, a secondary battery includes an electrode assembly; and a pouch including an upper sheet and a lower sheet and accommodating the electrode assembly. The pouch is formed with a sealing portion sealing the upper sheet and the lower sheet on an outer portion. The sealing portion includes a polymer compound layer between the top sheet and the bottom sheet in at least a portion. The polymer compound layer includes a polymer compound, and the polymer compound is a thermally expandable polymer compound of a composite of a hydroxy group-containing polymer and silica; or at least one heat-shrinkable polymer compound selected from the group comprising polyphenylene ether (PPE), polycarbonate (PC), polyoxymethylene (POM) and polyamide (PA).

The composite of the hydroxy group-containing polymer and silica may be a polyurethane-silica hybrid.

The polymer compound layer may be formed on a portion or an entirety of a width of the sealing portion.

The polymer compound layer may be formed on a sealing portion of a surface from which an electrode lead is drawn out.

The polymer compound layer may have a thickness of 3 to 25 μm.

The polymer compound layer may include a thermally expandable polymer compound, and may have a volume at 80° C. or higher, which is 30 to 4,000 times a volume at room temperature.

The polymer compound layer may include a heat-shrinkable polymer compound, and may have a volume at 80° C. or higher, which is 0.02 to 0.9 times a volume at room temperature.

The polymer compound may be in the form of beads, pillars, flakes, or powder.

The polymer compound may include expanded graphite filled inside of the polymer compound.

### BRIEF DESCRIPTION OF DRAWINGS

Certain aspects, features, and advantages of the disclosed technology are illustrated by the following detailed description with reference to the accompanying drawings.

FIG. 1 schematically illustrates a secondary battery according to an embodiment.

FIG. 2 is a view schematically illustrating a cross section of a pouch in which a polymer compound layer is formed on a first resin layer.

FIG. 3 is a schematic view of a cross section taken along line I-I′ of FIG. 1, as a sealing portion including a polymer compound layer.

FIG. 4 is a view schematically illustrating the concept of forming a gas discharge passage when a polymer compound layer including a thermally expandable polymer compound is formed on a portion of a sealing portion.

FIG. 5 is a diagram schematically illustrating the concept of forming a gas discharge passage when a polymer compound layer including a heat-shrinkable polymer compound is formed on a portion of a sealing portion.

### DETAILED DESCRIPTION

Features of the disclosed technology disclosed in this patent document are described by example embodiments with reference to the accompanying drawings.

Elements indicated with the same reference numerals in the accompanying drawings to aid understanding of the description of the embodiments are the same elements, and among the components that perform the same action in respective embodiments, related components are indicated by the same or similar reference numerals.

In addition, to clarify the gist of the present disclosure, descriptions of elements and techniques well known by the related art will be omitted. Hereinafter, the present disclosure will be described in detail with reference to the accompanying drawings.

However, the spirit of the present disclosure is not limited to the presented embodiments, and may be suggested in other forms in which specific components are added, changed, or deleted by those skilled in the art, and it should be noted that this is also included within the scope of the same spirit as the present disclosure.

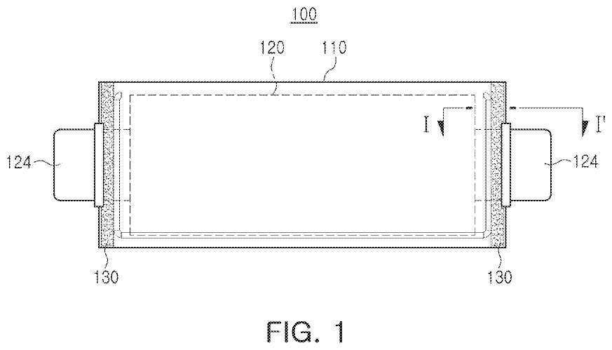

FIG. 1 schematically illustrates a secondary battery 100 according to an embodiment. As illustrated in FIG. 1, the secondary battery 100 includes a pouch 110, an electrode assembly 120 is accommodated inside of the pouch 110, and an electrolyte (not illustrated) may be filled therein.

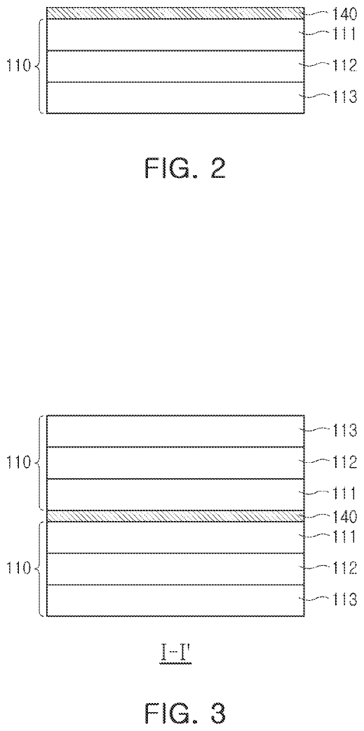

In an embodiment, the pouch 110 is not particularly limited in shape, material, and the like, as long as it is generally used in the field of secondary batteries. For example, as illustrated in FIG. 2, the pouch 110 may be formed by sequentially stacking a first resin layer 111, a metal layer 112, and a second resin layer 113, and an adhesive layer (not illustrated) for bonding the metal layer 112 and the second resin layer 113 may be present between the metal layer 112 and the second resin layer 113. Although not particularly limited, the first resin layer 111 provides thermal adhesion, and may be composed of a polyolefin-based resin such as a polypropylene (PP) resin, and the second resin layer 113 may be formed of at least one of a nylon resin and a polyethylene terephthalate (PET) resin. On the other hand, the metal layer 112 may be an aluminum foil.

The pouch 110 may include an upper sheet and a lower sheet, and the upper sheet and the lower sheet may have the same material. The upper sheet and the lower sheet may be separated from each other, and one pouch may be folded to provide the upper sheet and the lower sheet.

In a state in which the electrode assembly is accommodated, the first resin layer 111 of the upper sheet and the first resin layer 111 of the lower sheet may be directly opposed to each other and sealed by applying heat and pressure thereto. In this case, when the pouch is separated into the upper sheet and the lower sheet, four sides may be sealed, and when one pouch is folded and provided as the upper sheet and the lower sheet, three sides may be sealed. Furthermore, if necessary, an envelope-type pouch may be used, and in this case, two-side sealing or one-side sealing may be performed.

In an embodiment, the electrode assembly 120 is accommodated in the pouch 110. In the electrode assembly 120, at least one positive electrode in which a positive electrode mixture layer containing a positive electrode active material is provided on at least one surface of a positive electrode current collector may be provided, at least one negative electrode in which a negative electrode mixture layer containing a negative electrode active material is provided on at least one surface of a negative electrode current collector may be provided, and a separator may be interposed between the positive electrode and the negative electrode.

For example, the electrode assembly 120 may be a stack type electrode assembly in which a plurality of positive electrodes and negative electrodes are alternately stacked and a separator is interposed between the positive electrode and the negative electrode, may be a stack-and-folding type electrode assembly in which a plurality of positive electrodes and negative electrodes are alternately stacked with each other by folding a rectangular separator, or may be a winding type electrode assembly in which a rectangular positive electrode and a rectangular negative electrode and a rectangular separator between the positive electrode and the negative electrode are stacked and wound in one direction, and may be a combination of two or more thereof.

The electrode assembly 120 may include an electrode tab (not illustrated) in which electrode uncoated portions drawn from electrode current collectors of respective electrodes are collected. The electrode tabs of the negative electrode and the positive electrode may be drawn out in one direction of the electrode assembly or in both directions. The electrode tab may be formed extending from an electrode collector of the electrode assembly 120 toward the outside of the pouch 110 to serve as a path for electrons to move between the inside and outside of the pouch 110.

An electrode lead 124 may be connected to the electrode tab. In this case, the connection method between the electrode tab and the electrode lead 124 is not particularly limited, and for example, the electrode tab may be connected to the electrode lead 124 by welding. A portion of the electrode lead 124 is exposed to the outside of the pouch 110, and the electrode lead 124 exposed to the outside of the pouch 110 may be electrically connected to an external terminal.

In an embodiment, in a state in which the electrode lead 124 is drawn out of the pouch 110, the first resin layers of the upper and lower sheets face each other and are heat-sealed to form the sealing portion 130. Although not particularly limited, the sealing portion 130 may be formed along the outer side of the pouch 110, and as described above, the sealing portion may be formed on three or four sides of the pouch, and in detail, may be formed on a surface on which the electrode lead 124 is present in the outer side portion of the pouch 110.

On the other hand, a sealant portion is provided on at least one surface of the electrode lead 124 on the surface where the electrode lead 124 is present, and the first resin layer 111 of the upper sheet and the first resin layer 111 of the lower sheet may be sealed via the sealant portion.

In the case of a secondary battery, when the internal temperature rises, the electrolyte may vaporize or a gas is generated due to a side reaction between the electrolyte and the electrode, and thus, the pressure inside of the cell increases and a thermal runaway phenomenon in which the pouch expands may occur. When such a thermal runaway phenomenon occurs in one cell, heat propagates to an adjacent cell, causing a chain of thermal runaway and fire.

Accordingly, in an embodiment of the present disclosure, in the case in which a thermal runaway phenomenon reaching a specific temperature or higher occurs, a vent capable of discharging gas and an electrolyte in a pouch is formed to prevent thermal runaway to stably maintain battery performance and to improve safety by preventing explosions and the like.

To this end, as an embodiment of the present disclosure, as illustrated in FIG. 2, a polymer compound layer 140 of which the volume is changed by heat may be formed on the inner surface of the pouch 110, for example, on the first resin layer 111.

The polymer compound layer 140 formed on the first resin layer 111 of the pouch 110 may include a polymer compound of which the volume changes as the temperature inside of the battery rises. In this case, the polymer compound is a thermally expandable polymer compound, and may be a heat-shrinkable polymer compound.

The temperature at which the volume of the polymer compound layer 140 changes is not particularly limited, but may be 80° C. or higher, for example, 80° C. or higher, 85° C. or higher, 90° C. or higher, or 100° C. or higher. On the other hand, the temperature may be 130° C. or less, in detail, 120° C. or less. In the case in which the volume changes due to heat at a temperature of 130° C. or lower, the sealing may be released even after the heat is generated in the cell, thereby discharging the gas and electrolyte inside of the battery, and thus, thermal propagation to the adjacent cell due to additional heat diffusion may be prevented, and in the case in which the volume changes at a temperature of 120° C. or less, thermal runaway may be prevented in advance.

Examples of the thermally expandable polymer compound included in the polymer compound layer 140 include, but are not limited to, a composite of a hydroxyl group-containing compound and silica. Examples of the composite of the hydroxyl group-containing compound and silica may include a composite of silica and polyurethane.

When the polymer compound layer 140 includes a thermally expandable polymer, the volume of the polymer compound layer 140 at 80° C. or higher may increase by 30 to 4,000 times compared to the volume of the polymer compound layer 140 at room temperature (25° C.).

On the other hand, examples of the heat-shrinkable polymer compound included in the polymer compound layer 140 may include polyphenylene ether (PPE), polycarbonate (PC), polyoxymethylene (POM), and polyamide (PA).

In the case in which the polymer compound layer 140 includes a heat-shrinkable polymer compound, the volume of the polymer compound layer 140 at 80° C. or higher decreases by 0.02 to 0.9 times compared to the volume of the polymer compound layer 140 at room temperature.

In an embodiment of the present disclosure, the polymer compound layer 140 may have a thickness of 3 μm to 25 μm. If the thickness is less than 3 μm, it may be difficult to discharge gas or electrolyte solution due to lack of expansion or contraction of the polymer compound layer 140, and as a result, performance and safety of the cell may be weakened. On the other hand, if the thickness of the polymer compound layer 140 exceeds 25 μm, the adhesiveness of the polymer compound layer 140 is weakened, and thus, the polymer compound layer 140 may not be properly adhered to the pouch, electrode assembly, or sealing portion, and the performance and safety of the cell may be weakened.

In an embodiment of the present disclosure, the shape of the polymer compound is not particularly limited, and for example, the polymer compound may be in the form of beads, pillars, flakes, or powder. Depending on the type of polymer compound and the location where the polymer compound layer 140 is formed, an appropriate type of polymer compound may be selected and used.

In addition to using the polymer compound itself, a polymer compound filled with expanded graphite therein may also be used. In this case, the expanded graphite means graphite that expands hundreds of times at a certain temperature or higher, and the component or manufacturing method thereof is not particularly limited.

The polymer compound layer 140 of which the volume changes may be formed on an inner surface of a pouch where a sealing portion is formed. FIG. 3 schematically illustrates an example in which a polymer compound layer is formed on the inner surface of a pouch in which a sealing portion is formed, and illustrates a cross-section of the sealing portion, taken along line I-I′ in FIG. 1.

In more detail, the sealing portion 130 is formed by thermal fusion between the first resin layer 111 of the upper sheet and the first resin layer 111 of the lower sheet, and as illustrated in FIG. 3, the polymer compound layer 140 may be provided between the first resin layer 111 of the upper sheet and the first resin layer 111 of the lower sheet. In this manner, when the sealing portion 130 is provided with the polymer compound layer 140, the polymer compound layer 140 expands or contracts as the internal temperature of the battery increases, and thus the adhesive strength of the sealing portion 130 may be weakened. Further, pressure may be concentrated on the sealing portion 130 with weakened adhesive force to form a vent, and gas or electrolyte discharge may be induced through the vent.

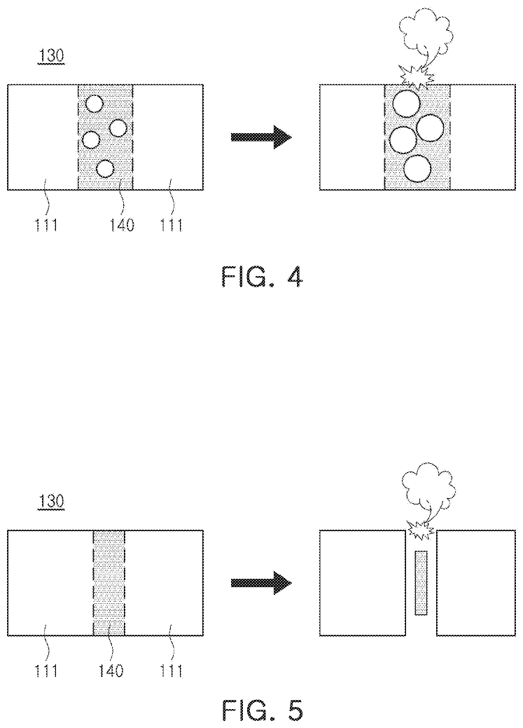

FIG. 4 is a diagram schematically illustrating the concept of forming a flow path through which gas may be discharged when the polymer compound layer 140 including a thermally expandable polymer compound is formed on a portion of the sealing portion 130. As illustrated in FIG. 4, when the polymer compound layer 140 including the thermally expandable polymer compound in a portion of the sealing portion 130 reaches the expansion temperature of the thermally expandable polymer in the battery, the polymer compound layer 140 expands due to heat, and thus, the sealing strength of the sealing portion 130 may be reduced. As a result, the gas generated inside of the battery is concentrated in the area where the sealing strength is weakened, and the sealing is released by applying pressure, thereby forming a flow path for gas discharge. Accordingly, discharging gas and electrolyte inside of the battery through the flow path may be induced to suppress additional temperature rise and battery explosion.

On the other hand, FIG. 5 is a diagram schematically illustrating the concept of forming a flow path through which gas may be discharged when the polymer compound layer 140 including a heat-shrinkable polymer compound is formed on a portion of the sealing portion 130. As illustrated in FIG. 5, when the polymer compound layer 140 including the heat-shrinkable polymer compound in a portion of the sealing portion 130 reaches the contraction temperature of the heat-shrinkable polymer in the battery, the polymer compound layer 140 shrinks due to heat, thereby forming a flow path for a decrease in sealing strength of the sealing portion 130 and gas discharge.

As illustrated in FIGS. 4 and 5, the polymer compound layer 140 may be formed in the width direction of the pouch sealing portion, for example, in the entirety in the I-I′ direction in FIG. 1, and although not illustrated in the drawings, may be formed in a partial area of the sealing portion in the width direction and the rest may be sealed between the first resin layers. For example, even when the polymer compound layer 140 is formed in a portion of the width of the sealing portion, the sealing strength of the sealing portion may be weakened as the polymer compound layer shrinks and expands due to heat, such that the gas generated inside the secondary battery is concentrated in the area where the sealing strength is weakened to release the sealing of the remaining sealing portion by the pressure of the gas. Therefore, the discharge of gas and electrolyte may be induced.

In addition, the polymer compound layer 140 may be formed on the sealing portion 130 formed on the surface from which the electrode lead 124 is drawn out. In the secondary battery, the temperature of the battery may be relatively higher on the portion where the electrode tab is located, and therefore, the amount of gas generated may be higher. Therefore, the polymer compound layer 140 may be formed on the sealing portion 130, which is connected to the electrode tab and from which the electrode lead 124 is drawn out, and accordingly, due to the volume expansion or contraction of the polymer compound layer 140 according to an increase in temperature of the battery, gas generated inside of the battery may be discharged more smoothly.

According to each embodiment provided in the present disclosure, a polymer compound layer including a polymer compound that expands or contracts by heat is formed on a sealing portion where the upper and lower sheets of the pouch are heat-sealed, and therefore, heat generated inside of the battery may cause contraction and expansion of the polymer compound layer. The sealing strength of the sealing portion may be reduced by the contraction and expansion of the polymer compound layer, and the gas generated inside of the battery is induced to concentrate in the area where the sealing strength of the sealing portion is weakened to release the sealing, thereby forming a flow path for discharge. Therefore, gas or electrolyte may be discharged through the formed flow path, and accordingly, an additional temperature rise may be suppressed and the safety of the battery may be secured.

As set forth above, according to an embodiment, a secondary battery including a polymer compound layer of which the volume changes at a specific temperature or higher is provided, and heat propagation to the remaining cells in the pack and module may be prevented by suppressing thermal explosion at the cell-level, thereby stably maintaining performance of the secondary battery and securing the safety of the battery.

Only specific examples of implementations of certain embodiments are described. Variations, improvements and enhancements of the disclosed embodiments and other embodiments may be made based on the disclosure of this patent document.

What is claimed is:

1. A secondary battery comprising:
an electrode assembly; and
a pouch including an upper sheet and a lower sheet and accommodating the electrode assembly,
wherein the pouch is formed with a sealing portion sealing the upper sheet and the lower sheet on an outer portion,
the sealing portion includes a polymer compound layer between the top sheet and the bottom sheet in at least a portion, and
the polymer compound layer includes a polymer compound, the polymer compound is a thermally expandable polymer compound of a composite of a hydroxy group-containing compound and silica; or at least one heat-shrinkable polymer compound selected from the group comprising polyphenylene ether (PPE), polycarbonate (PC), polyoxymethylene (POM) and polyamide (PA).

2. The secondary battery of claim 1, wherein the composite of the hydroxy group-containing compound and the silica is a composite of polyurethane and silica.

3. The secondary battery of claim 1, wherein the polymer compound layer is formed on a portion or an entirety of a width of the sealing portion.

4. The secondary battery of claim 1, wherein the polymer compound layer is formed on the sealing portion of a surface from which the electrode lead is drawn out.

5. The secondary battery of claim 1, wherein the polymer compound layer has a thickness of 3 to 25 μm.

6. The secondary battery of claim 1, wherein the polymer compound layer includes a thermally expandable polymer compound, and has a volume at a temperature of 80° C. or higher, which is 30 to 4,000 times a volume at room temperature.

7. The secondary battery of claim 1, wherein the polymer compound layer includes a heat-shrinkable polymer compound, and has a volume at 80° C. or higher, which is 0.02 to 0.9 times a volume at room temperature.

8. The secondary battery of claim 1, wherein the polymer compound is in a form of a bead, a pillar, a flake, or powder.

9. The secondary battery of claim 1, wherein the polymer compound comprises expanded graphite filled inside of the polymer compound.
